(19) United States
(12) Patent Application Publication
(10) Pub. No.: US 2012/0284360 A1
(43) Pub. Date: Nov. 8, 2012

(54) JOB PLANNER AND EXECUTION ENGINE FOR AUTOMATED, SELF-SERVICE DATA MOVEMENT

(75) Inventors: Peter Tillman Bense, San Jose, CA (US); Rallie N. Rualo, Fairfield, CA (US)

(73) Assignee: eBay Inc., San Jose, CA (US)

(21) Appl. No.: 13/443,707

(22) Filed: Apr. 10, 2012

Related U.S. Application Data
(60) Provisional application No. 61/474,190, filed on Apr. 11, 2011.

(51) Int. Cl. G06F 15/16

(52) U.S. Cl. 709/217

(57) ABSTRACT

A system and method for facilitating data movement between a source system and a target system is disclosed. A user interface module is configured to generate a user interface that receives a request to move data from a source system to a target system. A job planner module is configured to receive the request and generate a migration plan based on the request. A heartbeat agent module is configured to execute tasks included in the migration plan, the execution of the tasks causing the data to be moved from the source system to the target system.

### CROSS-REFERENCE TO RELATED APPLICATIONS

This application claims the benefit of priority under 35 U.S.C. §119(e) to U.S. Provisional Patent Application Ser. No. 61/474,190, entitled “JOB PLANNER AND EXECUTION ENGINE FOR AUTOMATED, SELF-SERVICE DATA MOVEMENT,” filed on Apr. 11, 2011, which is incorporated by reference herein in its entirety.

### TECHNICAL FIELD

Example embodiments of the present disclosure relate generally to a system and method for automated, load-balanced movement of data between systems.

### BACKGROUND

Through business operations and day-to-day activities, entities generate large amounts of data that are stored for use and re-use in business and analytical operations, among other things. In certain instances, these entities operate and maintain data warehouses and/or data centers to store this data. To operate on the stored data, it is common to use a process called “Extract, Transform, and Load” (ETL) to extract data from sources, transform the data using rules or functions into a set of data for use by a target device, and load the data into the target device. However, defining and implementing the steps to accomplish the migration of data according to an ETL process can be time consuming.

### BRIEF DESCRIPTION OF THE DRAWINGS

Example embodiments of the present disclosure are illustrated by way of example, and not by way of limitation, in the figures of the accompanying drawings.

FIG. 1 is a diagram depicting a network system, according to some embodiments, having a client-server architecture configured for exchanging data over a network.

FIG. 2 is a diagram depicting a network system, according to some embodiments, having multiple systems configured for exchanging data over a network.

FIG. 3A is a diagram illustrating example modules of a computer system, according to some embodiments,

FIG. 3B is a diagram illustrating example modules of a module in a computer system, according to some embodiments,

FIG. 4 is a flow diagram of an example method for composing a data migration plan, according to some embodiments.

FIG. 5 is a flow diagram of an example method for monitoring the execution of data migration plans, according to some embodiments.

FIG. 6 is a diagram of an example user interface for facilitating migration of data, according to some embodiments.

FIG. 7 is a diagram of an example user interface for facilitating migration of data, according to some embodiments.

FIG. 8 is a diagram of an example user interface for facilitating migration of data, according to some embodiments.

FIG. 9 is a diagram of an example user interface for facilitating migration of data, according to some embodiments.

FIG. 10 is a diagram of an example user interface for facilitating migration of data, according to some embodiments.

FIG. 11 is a diagram of an example data model for facilitating migration of data, according to some embodiments.

FIG. 12 is a diagram depicting a network system configured to facilitate the migration of data, according to some embodiments.

FIG. 13 shows a diagrammatic representation of a machine in the example form of a computer system within which a set of instructions may be executed to cause the machine to perform any one or more of the methodologies discussed herein.

### DETAILED DESCRIPTION

Systems, methods, and machine-readable storage media storing a set of instructions for migrating data between different systems and different data centers are disclosed. In the following description, for purposes of explanation, numerous specific details are set forth in order to provide a thorough understanding of the present disclosure. It may be evident, however, to one skilled in the art that the subject matter of the present disclosure may be practiced without these specific details.

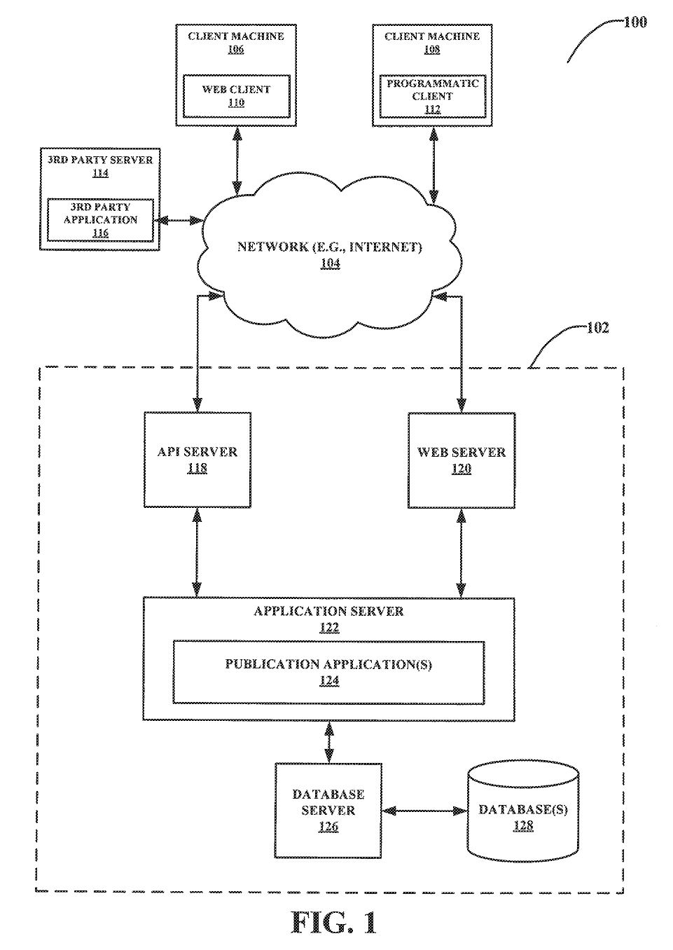

FIG. 1 is a network diagram depicting a network system 100, according to one embodiment, having a client-server architecture configured for exchanging data over a network. For example, the network system 100 may be a publication/publisher system 102 where clients may communicate and exchange data within the network system 100. The data may pertain to various functions (e.g., selling and purchasing of items) and aspects (e.g., data describing items listed on the publication/publisher system) associated with the network system 100 and its users. Although illustrated herein as a client-server architecture as an example, other example embodiments may include other network architectures, such as a peer-to-peer or distributed network environment.

A data exchange platform, in an example form of a network-based publisher 102, may provide server-side functionality, via a network 104 (e.g., the Internet) to one or more clients. The one or more clients may include users that utilize the network system 100 and more specifically, the network-based publisher 102, to exchange data over the network 114. These transactions may include transmitting, receiving (communicating) and processing data to, from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (Ins). The UIs may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server 114 hosting a third party application 116. It can be appreciated in various embodiments the client machine 106, 108, or third party application 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

Turning specifically to the network-based publisher 102, an application program interface (API) server 118 and a web server 120 are coupled to, and provide programmatic and web interfaces respectively to, one or more application servers 122. The application servers 122 host one or more publication application (s) 124. The application servers 122 are, in turn, shown to be coupled to one or more database server(s) 126 that facilitate access to one or more database(s) 128.

In one embodiment, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., client application 112 or third party application 116) running on another client machine (e.g., client machine 108 or third party server 114).

The publication application(s) 124 may provide a number of publisher functions and services (e.g., search, listing, payment, etc.) to users that access the network-based publisher 102. For example, the publication application(s) 124 may provide a number of services and functions to users for listing goods and/or services for sale, searching for goods and services, facilitating transactions, and reviewing and providing feedback about transactions and associated users. Additionally, the publication application(s) 124 may track and store data and metadata relating to listings, transactions, and user interactions with the network-based publisher 102.

FIG. 1 also illustrates a third party application 116 that may execute on a third party server 114 and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher or payment functions that are supported by the relevant applications of the network-based publisher 102.

Data exchanged or generated by the various components of the network-based publisher 102 and/or the client machines connected to the network-based publisher 102 illustrated in FIG. 1 may be stored in one or more data centers, data warehouses, or other storage systems.

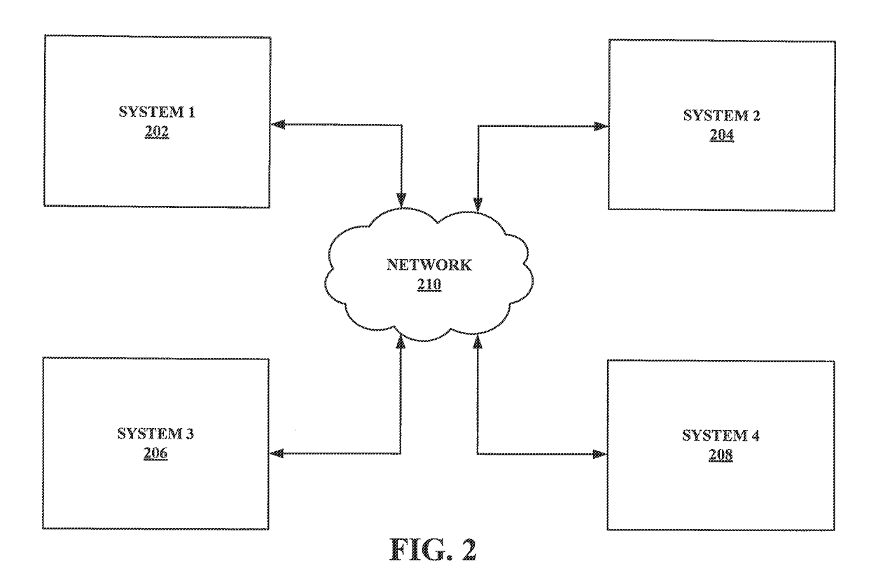

FIG. 2 is a diagram depicting a network system, according to some embodiments, having multiple systems configured for exchanging data over a network. Referring to FIG. 2, systems 202, 204, 206, 208 may represent network-based systems capable of storing and exchanging data. In some embodiments, the systems 202, 204, 206, 208 may represent storage systems, such as data centers or data warehouses, or one or more servers and clients. In some embodiments, the systems 202, 204, 206, 208 may be geographically separated, but connected with each other via network 210. In some embodiments, the systems 202, 204, 206, 208 may be protected by firewall or other security systems. In some embodiments, the systems 202, 204, 206, 208 may store different data, while in other embodiments, at least some of the data stored by systems 202, 204, 206, 208 may be redundant or overlapping, Systems 202, 204, 206, 208 may be communicatively connected via network 210. In some embodiments, while not shown, systems 202, 204, 206, 208 also may communicate directly with other systems without routing such communications over network 210.

In some embodiments, a system, method, and machine-readable storage medium storing a set of instructions for allowing user-facing, on-demand, load-balanced, fully automated data movement between systems and data centers (geographies) are disclosed. A multi-tier, cross-platform application may facilitate the data movement between systems and data centers.

By way of background, and not by way of limitation, certain scenarios may entail the movement varying volumes of data (anywhere from megabytes to terabytes) between different systems, oftentimes of a completely different class (e.g. Teradata versus Hadoop—systems that are intrinsically designed for handling structured vs. unstructured data), and in different datacenters (e.g., Phoenix, Sacramento), These data movements often require multiple iterations before it can be decided that the data in question has an ability to generate some business value, and therefore that process that should be repeated (e.g. run in batches). These iterations may be expensive given the classic approach of Extract, Transform, and Load (ETT), In a typical ETL paradigm, a data warehouse engineer needs to make a determination of the steps required to facilitate the end-to-end process. These steps often require new firewall ports to be opened, administrative accounts to be created and permissions granted on source/target and intermediate servers, and so forth. Furthermore, these tasks and processes are usually dependent upon multiple external teams necessitating ticketed work that requires (among other things): capacity review, security review, batch account creation, etc. Additionally, the tools needed to perform the various tasks to transfer data between systems may be custom tools or scripts created or used specifically for one or more of the systems. Given this milieu, this process often becomes very time intensive. In other words, while the sequence of operations might only take 10-15 minutes to run, the steps involved in setting up the process itself, given all the environmental complexities and external team dependencies, could take days or weeks. In a rapidly changing business climate, such lost time is a considerable hindrance to decision-supporting data analysis.

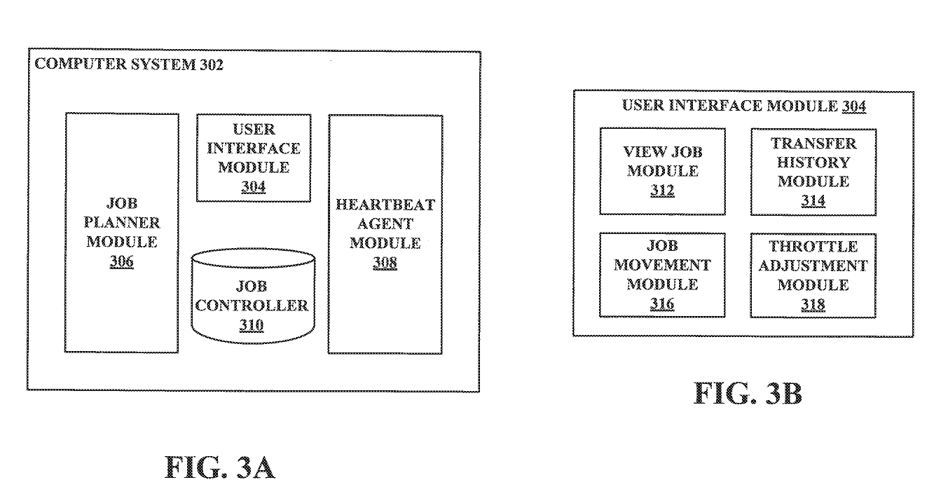

Example embodiments of the present disclosure disclose a multi-tier application that facilitates user-facing, on-demand, load-balanced, and fully automated data movement between systems and data centers (geographies). Referring to FIG. 3A, in some embodiments, the application framework has four components that enable the above functionality. The application framework may be embodied in the example embodiment of FIG. 3A in the form of a computer system 302. A first module is a user interface module 304, which may provide a web-based user interface (UI) that facilitates the user composing a movement request by selecting source and target systems. A second module may be a job planner module 306 that receives the movement request, validates it, and constructs a series of sequenced tasks that together comprise a “job plan” to fulfill the request. A third module may be a job controller 310. In some embodiments, the job controller 310 may be a relational database that stores metadata about job plans, source and target systems as well as intermediate hosts that may be used to facilitate a movement. A fourth module is a heartbeat agent module 308. In some embodiments, the heartbeat agent module 308 may be a daemon type multi-threaded process that runs on commodity servers that communicates with the job controller 310 on a polling interval. The heartbeat agent module 308 may receive task from the job controller 310, execute them, and then respond with a return code.

Each of the user interface module 304, the job planner module 306, the job controller 310, and the heartbeat agent module 308 may be one or more modules implemented by one or more processors. The modules may be stored on one or more devices.

The user interface module 304 may provide a web-based UI that navigates nose/graphically through the composition of a movement request. The user may selects a source of data to be moved using the web-based UI. The user also may select one or more targets to which the data is sent. The user may be presented with a verification screen to confirm the selected source and destination targets. If the user is satisfied with the selections, the user may submit the requested data movement, and a confirmation may be presented to the user. The Web-based UI also may include a graphical interface that presents submitted requests. Each of the submitted requests may be selected to view more details concerning the data movement. The detailed view of a data movement may illustrate each step of the end-to-end process of moving data between two systems, along with the status of each step. When every step has been marked as a success, the transfer is complete.

The job planner module 306 may contain logic that enables the job planner module 306 to be able to construct a plan of action, that is, the sequencing of sets of events and the systems on which to execute them to fulfill a request for data movement. In response to the web-based UI being used to compose a “movement request,” the application may generate a message (e.g., an XML message), such as the example message illustrated below.

<?xml version=“1.0” encoding=“UTF-8”?>
<job_detail>

<common_properties>

<request_id>446</request_id>
<user_id>pbense</user_id>
<request_ts>2011-04-04 17:09:38</request_ts>
<security_check_completed>Y</security_check_completed>
<notification_method>email/notification_method>
<notification_param>“pbense@ebay.com”</notification_param>

</common_properties>

<source_system>
<system_name>Fermat</system_name>
<db>P_ATLAS_T</db>
<tbl>DW_LSTG_SAMPLE_10JAN10</tbl>
</source_system>

<target_systems>

<tgt_system>

<system_name>Athena</system_name>
<hdfs_user_name>pbense</hdfs_user_name>
<hdfs_user_group>hadoopc1_dev_apdarch</hdfs_user_group>

<hdfs_user_home_dir>/apps/apdarch/pbense/atlas_req_446</hdfs_user_home_dir>
</tgt_system>
</target_systems>

</job_detail>

The message may contain the parameters of a request, which define its source and target(s). The message may be the API for the job planner module 306. Once the message is received, the job planner module 306 may conduct the following actions which, in some embodiments, may be in order of lowest to highest complexity.

1. DTD Check: The job planner module 306 may perform a check to ensure that the XML request that has been provided adheres to the format of a known valid request. In other words, the XML request has to contain detail, properties, systems and their requisite attributes. In some embodiments, a function from the 1xml library is used to validate the Document Type Definition.

2. Argument Check: For each various type of source/target, certain parameters must be provided. As these parameters can be dynamic based on an evolving set of endpoints, the job planner module 306 may perform “dynamic” checking in the sense that the list of attributes required should be determined by querying the job controller 310 and composing an “attribute dictionary” at runtime. This in contrast to validating against a statically defined DTD as noted above.

3. Systems and Services check: Once the arguments are checked, the job planner module 306 may verify the systems needed by checking with the job controller 310. In some embodiments, verification may entail determining whether the requested system is available as an endpoint (e.g., Is there actually a host named “Caracal”?). Verification also may entail determining whether the requested system is currently enabled (e.g. not set as offline for maintenance, etc.). In some embodiments, verification may further entail determining whether to permit an operation if a system is available and enabled. For example, unloads might be allowed on the system named “Fermat” whereas loads are not permitted at the dim the request is submitted.

Once the message is validated, the tasks may be determined and submitted to the job planner module 306. The job planner module 306 may be configured to process the tasks and form a plan.

In some embodiments, the job planner module 306 may iterate over the (now validated) sources and targets and determine the sequence of actions to take. This process may be involved due to the following details that must be considered by the job planner module 306. First, actions themselves are determined. For example, the job planner module 306 may determine whether a transport step needed. In an example situation where all systems involved are in the same data center, a transport step may not be needed. In another example, the job planner module 306 may determine if the data migration tool is connecting to Teradata as a source system. If so, the job planner module 306 may determine what type of operation is needed to source the data. Second, the job planner module 306 may determine the systems on which the actions will be executed. For example, if an unload operation is needed from the source data center, the job planner module 306 may determine from which systems the unload operation will be executed. In another example, if a load operation is needed in a second data center, the job planner module 306 may determine from which systems the load operation will be executed. In some embodiments, the job planner module 306 may determine an appropriate action if the number of source and target systems are not the same. For example, the job planner module 306 may determine how an incongruent “system profile” is load-balanced such that the job may still execute and not create any hot spots (e.g., unequal processing load) across systems.

In some embodiments, the job planner module 306 may perform preparation activity if a plan is successfully created and the plan requires loading the data to a database system. The preparation activity may include ensuring that there is an empty table to load into. The preparation activity may further entail obtaining a definition for the table from its source, manipulating aspects of the table (e.g., the table name and/or other attributes of its definition being modified in accordance with user-specified inputs), and then applying the table to the target system.

In some embodiments, the job planner module 306 may submit and commit the original message (e.g., XML request) and the step plan (e.g., set of sequenced tasks) to the job controller 310 after the aforementioned validation, planning and setup processes are complete. In some embodiments, submit and commit actions are performed atomically (e.g., between a BEGIN and END statement, to ensure jobs never end up in the database in an impartial state).

In some embodiments, a benefit of metadata consolidation is that it allows a single area from which to monitor end-to-end execution of plans. The application may utilize this design to enable an operator console, bandwidth throttling and other functionalities that contribute to its scalability. This is also a requirement to facilitate job planning. Given this, the job controller 310 may contain metadata about several relevant domains, such as source and target Systems, and operations permitted to be run on each; data Movement Host Configuration—what systems are available from which to run the unload/load operations; user Requests—XML messages as received by the application; plans generated to fulfill requests comprised of a series of sequenced tasks that must execute in phases (tasks of the same phase may execute in parallel); and metadata about task execution—this captures information about things like number of bytes read, number of bytes written, return code from task, etc.

The heartbeat agent module 308 is the piece of multi-threaded software that runs in each of the distributed systems in various data centers and across the distributed systems in the various datacenters. This daemon/service runs across a collective of hosts. One rationale behind the concept of collectives is that there could be more than one group of systems in a given geography used to service a set of systems. The heartbeat agent module 308 may perform a sign-on process that tells the node what services it will be running. After sign-on, the heartbeat agent module 308 begins a loop that runs every n seconds, during which may be performed the following sequential actions:

En-queue new tasks if found;

Execute tasks; and

Report back success/failure of tasks to Job Controller.

The execution of the tasks is the “heavy lifting” process of executing work, Tasks may include (but are not limited to) following types:

Setup—create directory structures;

Breakdown—clean up intermediate files;

Load/Unload—TPT/HDFS Load/Unload; and

Transmit—send data to a remote system.

Each heartbeat agent module 308 may poll the system on which it operates for the status of the task(s) currently executing on the system. The heartbeat agent module 310 may report the status back to the job controller 310.

Referring to FIG. 3B, additional components of the user interface module 304 are illustrated. A view job module 312 may generate and provide a user interface (or components thereof) that enables a user to view the current status of a pending job. The status of the job may include the progress of individual tasks of a job plan, including the source and target of the task. A transfer history module 314 may generate and provide a user interface (or components thereof) that enables a user to view the history of completed jobs. The user interface may provide a listing of processed jobs and the ability for a user to select a job from the list of processed jobs to view additional details of the job. For example, the user may view the status of the tasks that comprise the job plan to determine, among other things, whether any tasks failed during processing. A job movement module 316 may provide a user interface (or components thereof) that facilitates the prioritization and movement of jobs in the queue for processing. Users may be provided with the option to reorder jobs in the queue using the user interface provided by the job movement module 316. A throttle adjustment module 318 may provide a user interface (or components thereof) and functionality to enable a user to adjust the amount of bandwidth and/or processing resources consumed by a job plan or individual tasks thereof. In some embodiments, throttling may be desirable to prevent excessively burdening a system or a channel by which data is being transmitted.

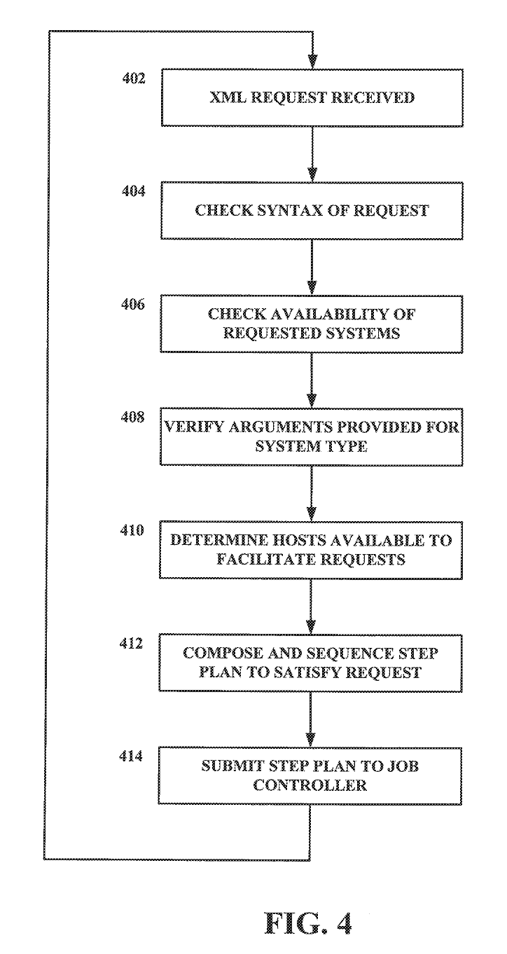

FIG. 4 is a flow diagram of an example method for composing a data migration plan, according to some embodiments. In some embodiments, the example method of FIG. 4 may be performed by the job planner module 306. At block 402, a movement request may be composed via a user interface, such as a web-based user interface. A message corresponding to the movement request may be generated. In some embodiments, the message may be an XML message. The message may contain the parameters of a request, such as defining the source and target(s) of the request. The message may be the API for the job planner module 306.

At block 404, the syntax of the request may be checked. In some embodiments, the job planner module 306 may perform a check to ensure that the request that has been provided adheres to the format of a known valid request. In other words, the request has to contain detail, properties, systems and their requisite attributes. In some embodiments, a function from the 1xml library is used to validate a Document Type Definition.

At block 406, the job planner module 306 may verify the systems needed by checking with the job controller 310. In some embodiments, verification may entail determining whether the requested system is available as an endpoint. Verification also may entail determining whether the requested system is currently enabled. In some embodiments, verification may further entail determining whether to permit an operation if a system is available and enabled. For example, unloads might be allowed on the system named “Fermat” whereas loads are not permitted.

At block 408, the job planner module 306 may determine whether certain parameters are provided for each various type of source or target. As these parameters can be dynamic based on an evolving set of endpoints, the job planner module 306 may perform “dynamic” checking in the sense that the list of attributes required should be determined by querying the job controller 310 and composing an “attribute dictionary” at runtime.

At block 410, the job planner module 306 may determine what hosts are available to facilitate the requests. The job planner module 306 may access the job controller 310 to determine which systems are available and capable of handling the request.

At block 412, the job planner module 306 may iterate over the (now validated) sources and targets and determine the sequence of actions to take. In some embodiments, actions themselves are determined. For example, the job planner module 306 may determine whether a transport step needed. In an example situation where all systems involved are in the same data center, a transport step may not be needed. In another example, the job planner module 306 may determine if the data migration tool is connecting to Teradata as a source system. If so, the job planner module 306 may determine what type of operation is needed to source the data. Second, the job planner module 306 may determine the systems on which the actions will be executed. For example, if an unload operation is needed from a first data center, the job planner module 306 may determine from which systems the unload operation will be executed from. In another example, if a load operation is needed in a second data center, the job planner module 306 may determine from which systems the load operation will be run from. In some embodiments, the job planner module 306 may determine an appropriate action if the number of source and target systems are not the same. For example, the job planner module 306 may determine how an incongruent “system profile” is load-balanced such that the job may still execute and not create any hot spots (e.g., unequal processing load) across systems.

At block 414, the job planner module 306 may submit and commit the original message (e.g., XML request) and the step plan (e.g., set of sequenced tasks) to the job controller 310 after the aforementioned validation, planning and setup processes are complete. In some embodiments, submit and commit actions are performed atomically (e.g., between a BEGIN and END statement, to ensure jobs never end up in the database in an impartial state). The example method may return to block 402 to detect whether another request has been received.

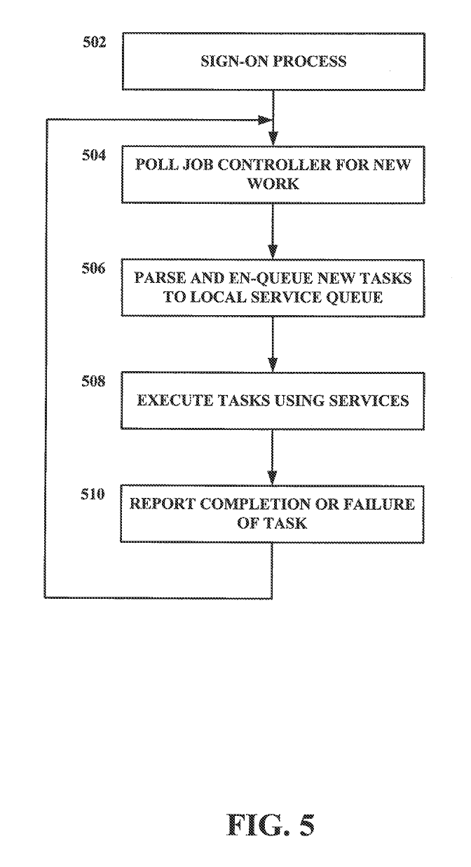

FIG. 5 is a flow diagram of an example method for monitoring the execution of data migration plans, according to some embodiments. In some embodiments, the example method of FIG. 5 may be performed by the heartbeat agent module 308. At block 502, a sign-on process is performed. The sign on process may inform the node what services it will be running. After sign-on, the heartbeat agent module 308 begins a loop that runs every n seconds.

At block 504, the job controller 310 may be polled to determine whether new work has been received for processing. If new work has been discovered, at block 506, the tasks may be parsed and queued in a local service queue.

At block 508, the queued tasks may be executed. Execution of the tasks may entail multiple sub-tasks, such as setup, breakdown, loading and/or unloading, and transmitting. Setup sub-tasks may create necessary directory structures to store data related to the executed task. Breakdown sub-tasks may be required to clean up intermediate files generated during processing of the task. Loading and unloading sub-tasks may loading and unloading required data to and from different types of systems, such as Teradata or Hadoop systems. Transmitting sub-tasks may entail sending data to a remote system. At block 510, the success or failure of the execution of the tasks may be reported to the job controller 310.

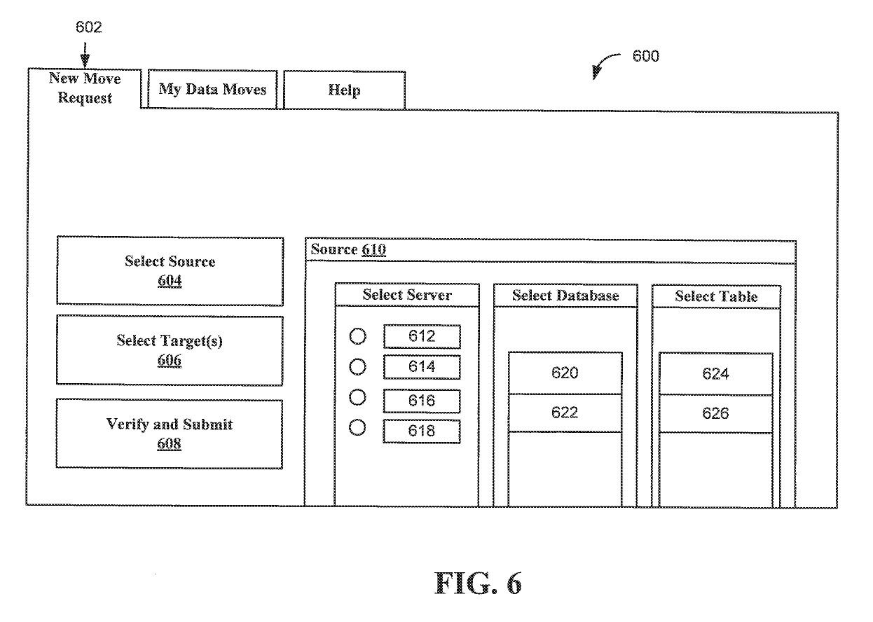

FIG. 6 is a diagram of an example user interface for facilitating migration of data, according to some embodiments. The example user interface 600 may permit a user to compose a data movement request. The user interface may include a tab for new data movement requests 602. Selection of the tab may provide a user interface by which the user may select a source 604 of data to be moved. The source selection 604 may provide a list of available sources 612, 614, 616, 618 along with selectable user interface elements (e.g., bubbles, check boxes, buttons). In some embodiments, the sources may represent data centers or individual servers within a data center or data warehouse. In some embodiments, once a source is selected, one or more databases 620, 622 maintained within the selected source may be provided for selection. The user may select one or more of the databases as sources to obtain data for data movement. Similarly, once a database is selected, one or more tables 624, 626 within the selected database may be provided for selection by the user.

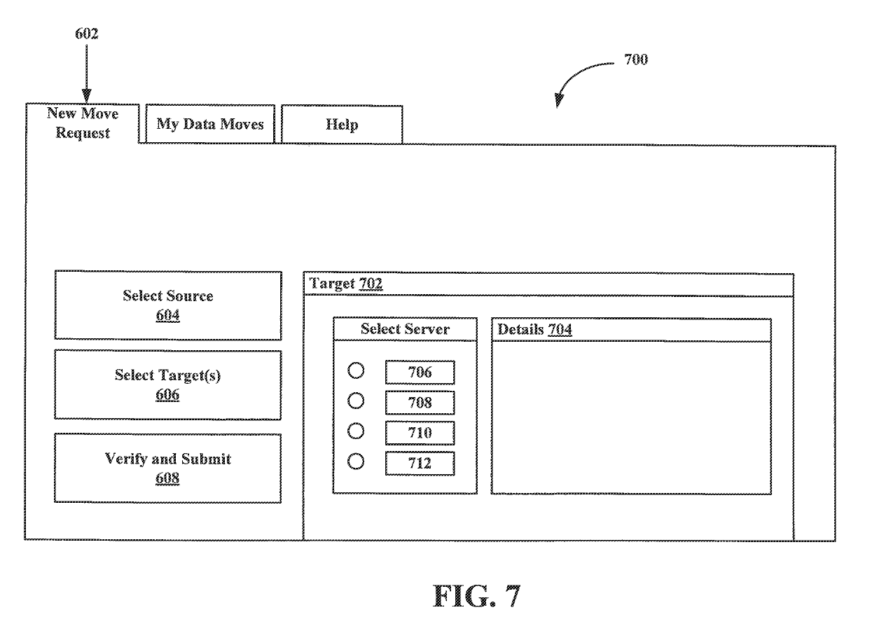

FIG. 7 is a diagram of an example user interface fix facilitating migration of data, according to some embodiments. In the user interface of FIG. 7, various target options may be provided for determining a target of a data movement request. In some embodiments, selection of the target may proceed following the selection of the source, as described with reference to the example embodiment of FIG. 6. The user interface 700 may provide a table 702 containing selection options for a target system that is to receive migrated data. The table 702 may include a list of target systems 706, 708, 710, 712 to which to transmit data. The target systems may be data centers, servers, or other storage or network devices. Selection of a particular target device may populate a “Details” table with relevant information about the selected target device. Relevant information may include such things as the name of the system, a user name of the user used to access the system, a group to which the target device belongs, and a home directory that may be associated with the user. The user interface may permit the user to add additional targets after selecting the first target.

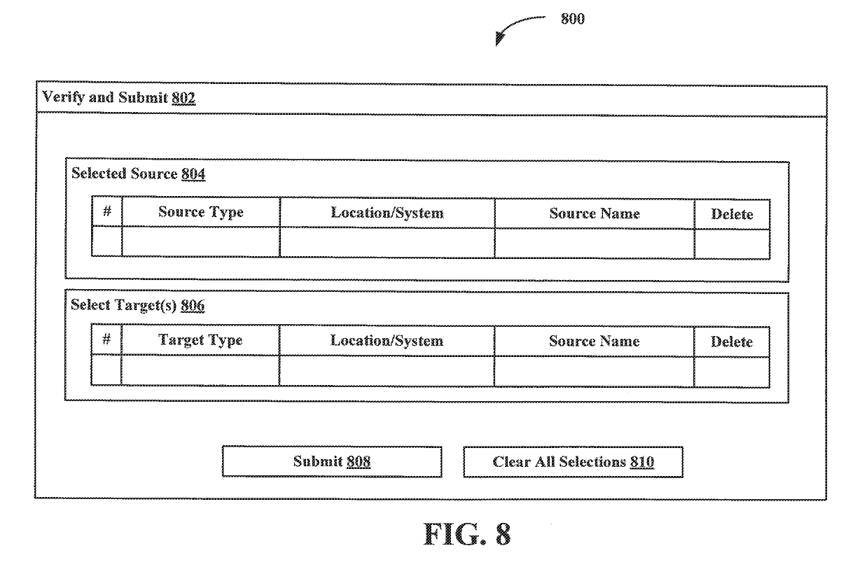

FIG. 8 is a diagram of an example user interface for facilitating migration of data, according to some embodiments. Referring to FIG. 8, a verify and submit user interface is depicted. The verify and submit user interface may specify the selected source and target systems for the data migration request. Information about the selected source may be provided for review by the user. Such information may include the type of system from which data is being transferred, a location of the system, and a name of the system. The user interface may further include functionality that enables a user to delete a source or a target in the event a source or target system is no longer desired to be a part of the data migration plan. Similar information may be presented for the selected target systems. If a user is satisfied with the selection of the source and target systems, the user may select a submit button that then causes the request to be transmitted to the job planner module 306 and/or stored in the job controller 310.

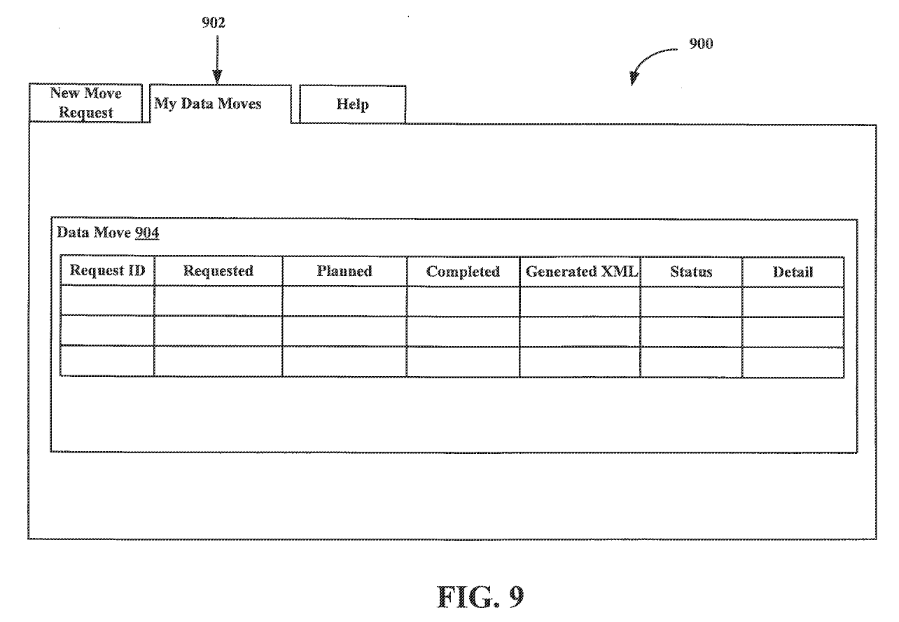

FIG. 9 is a diagram of an example user interface for facilitating migration of data, according to some embodiments. Referring to FIG. 9, a user interface for viewing submitted data migration job plans is depicted. The user interface may be accessed by selection of the tab 902. A table 904 may specify details of submitted data migration requests. In some embodiments, details may include a request identifier assigned to the submitted request, the date and time of submission of the request, a date and time for a planned execution of the request, a date and time of completion of the execution of the request, XML or other data generated during processing of the request, and a status of the request. The table 904 may further include a linked reference to a further user interface that specifies additional details about a job request.

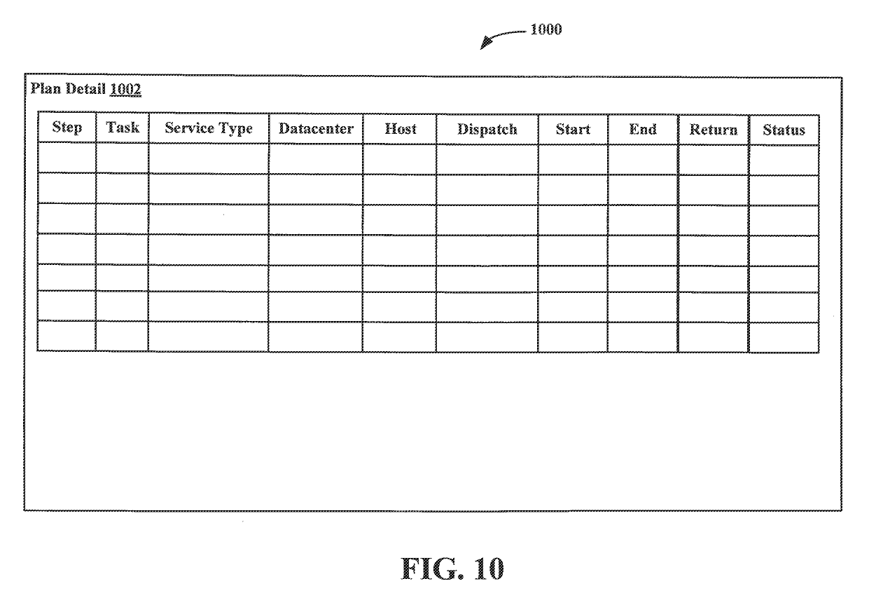

FIG. 10 is a diagram of an example user interface for facilitating migration of data, according to some embodiments. Referring to FIG. 10, a user interface 1000 for viewing details about a submitted job request is depicted. The details may be presented in a plan details table 1002 that further breaks down a job request into individual tasks and provides information about each individual task. For example, although not shown in FIG. 10, the details may include a step and task, where multiple tasks may belong to a step, a service type associated with the task, a datacenter responsible for executing the task, a host for facilitating the execution of the task, and various date and times associated with dispatch of the task, a starting time for the task, an ending time for the task, a time when the results of the task execution were returned, and a status of the task execution (e.g., success, ready, waiting, failure).

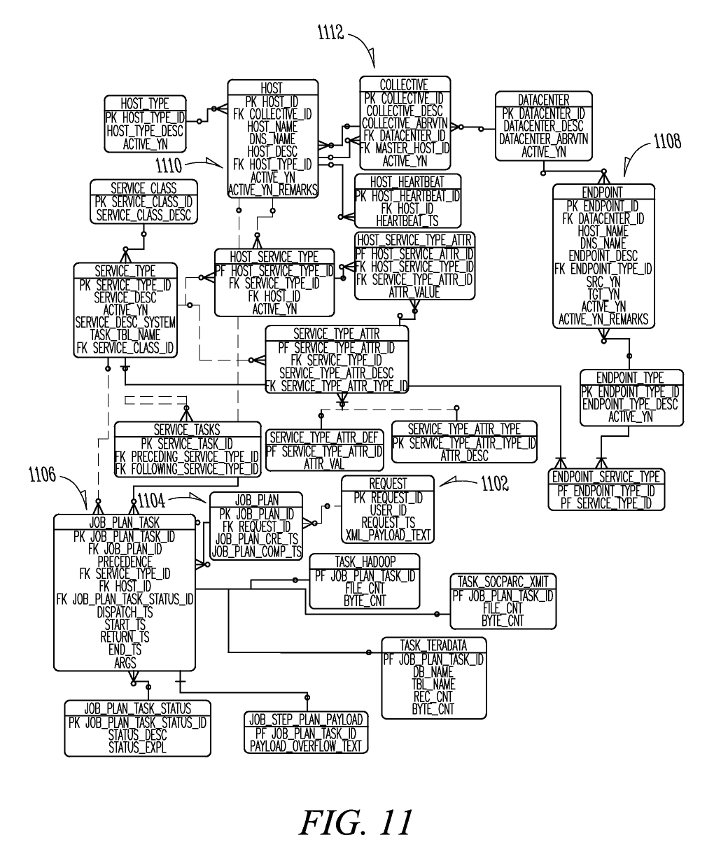

FIG. 11 is a diagram of an example data model for facilitating migration of data, according to some embodiments. Referring to FIG. 11, a graphic of the normalized data model that contains attributes in the job Controller and their relationships with one another is depicted. A REQUEST entity 1102 contains the XML payload of a user request. A JOB_PLAN entity 1104 records the instance of a job plan being generated for the request. A JOB_PLAN_TASK entity 1106 records the tasks and their sequence generated to satisfy the job plan. An ENDPOINT entity 1108 specifies the origin or destination of data. A HOST entity 1110 specifies a commodity system on which tasks are run. A COLLECTIVE entity 1112 specifies a group of HOST(s) in a DATACENTER. Other entities contain configuration parameters, return payload from task execution, and lookup tables referenced by various components of the application, among other things.

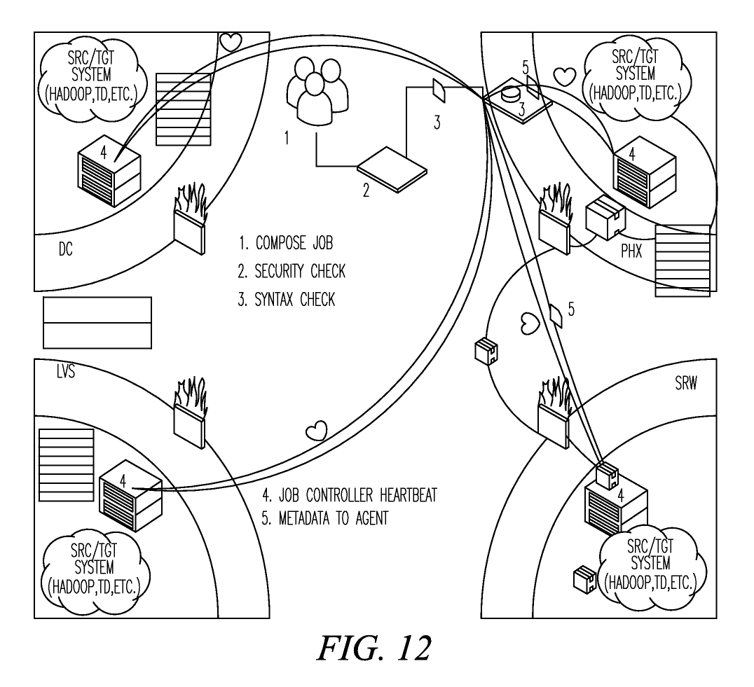

FIG. 12 is a diagram depicting a network system configured to facilitate the migration of data, according to some embodiments. Referring to FIG. 12, a diagram showing how the components described herein may work together to create an end-to-end solution for moving data between different systems and different data centers. The diagram may illustrate the example methods discussed with reference to FIGS. 4 and 5 and the discussion of the various modules of the data migration application with respect to FIGS. 3A and 3B.

While embodiments of the present disclosure have discussed the movement of data between systems in the context of data analytics, these embodiments are merely non-limiting examples. The example embodiments of the present disclosure may be applicable to other applications that require or involve the movement of data, and in particular, large amounts of data, between systems.

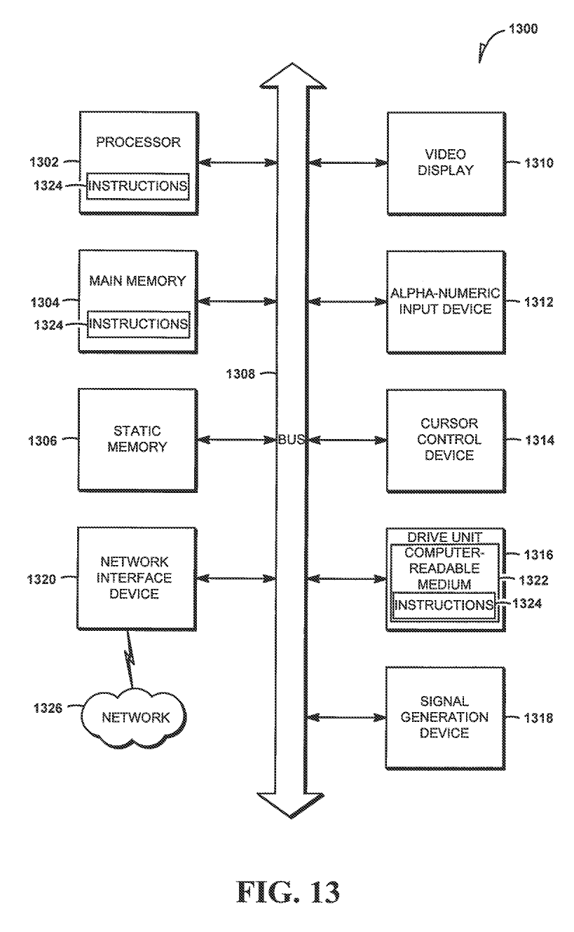

FIG. 13 shows a diagrammatic representation of machine in the exemplary form of a computer system 1300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (FDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU) a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a cursor control device 1314 (e.g., a mouse), a disk drive unit 1316, a signal generation device 1318 (e.g., a speaker) and a network interface device 1320.

The disk drive unit 1316 includes a machine-readable medium 1322 on which is stored one or more sets of instructions (e.g., software 1324) embodying any one or more of the methodologies or functions described herein. The software 1324 may also reside, completely or at least partially, within the main memory 1304 and/or within the processor 1302 during execution thereof by the computer system 1300, the main memory 1304 and the processor 1302 also constituting machine-readable media. The software 1324 may further be transmitted or received over a network 1326 via the network interface device 1320.

While the machine-readable medium 1322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

Certain embodiments are described herein as including logic or a number of components, modules, or mechanisms, Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 1300) or one or more hardware modules of a computer system (e.g., a processor 1302 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 1302 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a processor 1302 configured using software, the processor 1302 may be configured as respective different hardware modules at different times. Software may accordingly configure a processor 1302, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1302 that are temporarily configured (e.g., by software, code, and/or instructions stored in a machine-readable medium) or permanently configured to perform the relevant operations. Whether temporarily or permanently configured, such processors 1302 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 1302 or processor-implemented (or computer-implemented) modules. Similarly, at least some of the operations of a method may be governed by instructions that are stored in a computer readable storage medium and executed by one or more processors 1302 or processor-implemented (or computer-implemented) modules. The performance of certain of the operations may be distributed among the one or more processors 1302, not only residing within a single machine, but deployed across a number of machines. In some example embodiments, the processors 1302 may be located in a single location (e.g., within a home environment, an office environment or as a server farm), while in other embodiments the processors 1302 may be distributed across a number of locations.

While the embodiment(s) is (are) described with reference to various implementations and exploitations, it will be understood that these embodiments are illustrative and that the scope of the embodiment(s) is not limited to them. In general, techniques for the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually, and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

What is claimed is:

1. A system, comprising:
at least one processor;
a user interface module implemented by the at least one processor and configured to generate a user interface that receives a request to move data from a source system to a target system;
a job planner module implemented by the at least one processor and configured to receive the request and generate a migration plan based on the request; and
a heartbeat agent module implemented by the at least one processor and configured to execute tasks included in the migration plan, the execution of the tasks causing the data to be moved from the source system to the target system.

2. The system of claim 1, further comprising a job controller configured to store the migration plan and data relating to a plurality of source systems and a plurality of target systems.

3. The system of claim 2, wherein the data relating to the plurality of source systems and the plurality of target systems includes system type data and availability data of the plurality of source systems and the plurality of target systems.

4. The system of claim 1, wherein the user interface enables a user to specify the source system and the target system, the specification of the source system including a specification of a database and a database table from which data is to be moved.

5. The system of claim 1, wherein the job planner module is configured to generate the migration plan by:
validating the request;
verifying the availability of the source system and the target system; and
determining one or more tasks to facilitate the moving of the data from the source system to the target system.

6. The system of claim 1, wherein the user interface module further comprises:
a throttle adjustment module configured to adjust one of a processing resource allocation at at least one of the source system and the target system and a bandwidth allocation.

7. The system of claim 1, wherein the heartbeat agent module is further configured to:
poll a job controller for received requests;
parse received requests; and
queue tasks associated with the received requests in a local service queue.

8. A method, comprising:
receiving, via a user interface of a web-based application, a request to move data from a source system to a target system;
generating, by at least one processor, a migration plan based on the request; and
executing tasks included in the migration plan, the execution of the tasks causing the data to be moved from the source system to the target system.

9. The method of claim 8, further comprising storing the migration plan and data relating to a plurality of source systems and a plurality of target systems.

10. The method of claim 9, wherein the data relating to the plurality of source systems and the plurality of target systems includes system type data and availability data of the plurality of source systems and the plurality of target systems.

11. The method of claim 8, further comprising providing the user interface, the user interface enabling a user to specify the source system and the target system, the specification of the source system including a specification of a database and a database table from which data is to be moved.

12. The method of claim 8, wherein generating the migration plan comprises:
validating the request;
verifying the availability of the source system and the target system; and
determining one or more tasks to facilitate the moving of the data from the source system to the target system.

13. The method of claim 8, further comprising adjusting one of a processing resource allocation at at least one of the source system and the target system and a bandwidth allocation.

14. The method of claim 8, further comprising:
polling a job controller for received requests;
parsing received requests; and
queuing tasks associated with the received requests in a local service queue.

15. A machine-readable storage medium storing a set of instructions which, when executed by at least one processor, causes the at least one processor to perform operations comprising:
receiving, via a user interface of a web-based application, a request to move data from a source system to a target system;
generating, by at least one processor, a migration plan based on the request; and
executing tasks included in the migration plan, the execution of the tasks causing the data to be moved from the source system to the target system.

16. The machine-readable storage medium of claim 15, further comprising storing the migration plan and data relating to a plurality of source systems and a plurality of target systems.

17. The machine-readable storage medium of claim 16, wherein the data relating to the plurality of source systems and the plurality of target systems includes system type data and availability data of the plurality of source systems and the plurality of target systems.

18. The machine-readable storage medium of claim 15, further comprising providing the user interface, the user interface enabling a user to specify the source system and the target system, the specification of the source system including a specification of a database and a database table from which data is to be moved.

19. The machine-readable storage medium of claim 15, wherein generating the migration plan comprises:
validating the request;
verifying the availability of the source system and the target system; and
determining one or more tasks to facilitate the moving of the data from the source system to the target system.

20. The machine-readable storage medium of claim 15, further comprising adjusting one of a processing resource allocation at at least one of the source system and the target system and a bandwidth allocation.
